(19) United States
(12) Patent Application Publication
(10) Pub. No.: US 2012/0013132 A1
(43) Pub. Date: Jan. 19, 2012

(54) LOW EMISSIONS HYBRID VEHICLE

(75) Inventors: Howard Stephen LeBeau, Webberville, MI (US); Ronald Eugene Hannold, Charlotte, MI (US); Sherman Manley, Silver Spring, MD (US); William Frederick Foster, Grand Ledge, MI (US)

(73) Assignee: Spartan Motors, Inc.

(21) Appl. No.: 13/108,161

(22) Filed: May 16, 2011

Related U.S. Application Data
(60) Provisional application No. 61/345,950, filed on May 18, 2010.

(51) Int. Cl. B60L 1/00; H02K 7/18

(52) U.S. Cl. 290/1 R; 307/9.1; 180/65.21; 903/902

(57) ABSTRACT

One embodiment of the invention relates to a power system for a vehicle. The power system includes a first power source that is configured to provide power to the wheels of the vehicle. The power system further includes a second power source, an electrical system powered by the second power source, and an accessory powered by the second power source. The first power source does not provide power to the electrical system or to the accessory.

### CROSS REFERENCE TO RELATED PATENT APPLICATIONS

This application claims benefit of and priority to U.S. Provisional Patent Application No. 61/345,950, filed May 18, 2010. The foregoing provisional application is incorporated herein by reference in its entirety.

### BACKGROUND

The present application relates generally to the field of vehicle power systems. More specifically, the present application relates to power systems for medium-duty and heavy-duty vehicles.

Referring to FIG. 1, a conventional vehicle power system 10 is shown. The system 10 includes a single main power plant or power source 12. For medium and heavy duty trucks, the power source 12 is typically a diesel engine, but in other embodiments may also be a gasoline engine or another suitable portable power source. The power source 12 drives the wheels 14 to propel the vehicle. Typically, the output shaft of the power source 12 is coupled to a drive shaft 16 (e.g., through a transmission or other intermediary devices). The drive shaft 16, in turn, transfers the power to two or more wheels 14.

For a fire truck, the power source 12 may also be configured to drive a main water pump 40 for the vehicle. The main pump 40 is used to pump water from a source (e.g., a fire hydrant, a pool, a lake, etc.) so that the water or a foam can be output through hoses or stationary nozzles or deck guns.

As illustrated, in addition to the wheels 14, and the main water pump 40, the power source 12 further provides power to other devices. This is typically done by rotational transfer energy through belts and pulleys, or through direct drive through a power shaft. Vehicles powered by an internal combustion engine (e.g., gasoline engine, diesel engine) often include a serpentine belt. The serpentine belt is routed to engage an input pulley driven by the internal combustion engine and one or more output pulleys that are coupled to peripheral devices. The peripheral devices that are powered by the internal combustion engine represent parasitic loads. These parasitic loads include the chassis main alternator 18, main air conditioning (HVAC) compressor 20, as well as secondary alternators and compressors, hydraulic and pneumatic motors, secondary water pumps used for fire suppression, etc.

The main and secondary alternators convert a portion of the power output of the internal combustion engine to electrical power. The alternator 18 is coupled to one or more batteries 22. This electrical power is used to run various devices such as sensors, pumps, on-board computers, fans, etc. The compressor 20 may be a compressor for a vapor compression refrigeration system 24. The refrigeration system 24 further includes an evaporator 26, a condenser 28, and an expansion valve 29. Additional devices, such as fans, pumps, and electronics may also draw power from power source 12, either directly or through alternator 18. The internal combustion engine must be sized to provide power both to the parasitic loads and to the power train of the vehicle to drive the wheels. As such, the internal combustion engine is generally designed to be larger and have a larger power output than is needed to simply propel the vehicle.

Further, when the vehicle is stationary, the internal combustion may be idled to provide power to the parasitic loads. While idling, the large internal combustion engine may produce an excessive amount of noise and combustion pollution, as well as consume large amounts of fuel. Such idling periods may be especially significant for medium and heavy duty rescue and utility vehicles, such as fire trucks, delivery vehicles, ambulances, cranes, etc.

The usage of these non-high energy systems have typically higher duty cycle times than that of the high energy load requirements of the drive wheels and high power devices such as main fire pumps and therefore do not require the larger power and fuel consuming spent on a typical main power plant.

Fire trucks often include an auxiliary power unit in the form of a diesel generator. The generator can be used to provide power to hydraulic equipment, pumps, and other devices. As shown in FIG. 2, it is known for a system 30 to include a secondary power source 32 that is added to the vehicle 12 to supplement the first power source 12. When additional electrical current or additional heating and/or cooling is required by the vehicle, the secondary power source 32 is activated while the main power source 12 is operating, thus providing the additional energy or mechanical force necessary to keep such described systems operating.

This type of configuration may include a transfer switch 34 that provides for the power balancing between the main power plant alternator 18 and the secondary power source 32 for the prevention of over current over voltage difference caused by two independent electrical sources.

Mechanical power balancing must also be provided for through the use of solenoids 36 as illustrated to protect the main power plant air conditioning compressor 20 from pneumatic surges caused by a secondary power plant air conditioning compressor 38.

It would be desirable to provide an improved power system for a vehicle that reduces the load placed on the main power source from parasitic loads.

### SUMMARY

One embodiment of the invention relates to a power system for a vehicle. The power system includes a first power source that is configured to provide power to the wheels of the vehicle. The power system further includes a second power source, an electrical system powered by the second power source, and an accessory powered by the second power source. The first power source does not provide power to the electrical system or to the accessory.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a block diagram of a conventional vehicle drive system.

FIG. 2 is a block diagram of a prior art hybrid vehicle drive system.

FIG. 3 is a block diagram of a hybrid vehicle drive system according to an exemplary embodiment.

FIG. 4 is a block diagram of a hybrid vehicle drive system according to another exemplary embodiment.

### DETAILED DESCRIPTION

The following description refers to an improved power system for a medium or heavy duty vehicle. More specifically, the improved power system is described installed in a fire truck, such as a pumper truck, ladder truck, airport crash tender, etc. However, it should be understood that the innovative features are applicable to other heavy and medium duty vehicles, such as mobile trunk-mounted cranes, ambulances, utility vehicles, delivery vehicles, tanker trucks, refrigerator trucks, etc. The improved power system may also be useful for light vehicles, such as passenger vans, cars, trucks, SUVs, etc.

A second power source is added to the vehicle chassis. The second power source is configured to power all of the vehicle's parasitic loads, allowing the primary power source to be designed and optimized to provide power to the vehicle drive train. These parasitic loads include the chassis main and secondary alternator, main and secondary air conditioning (HVAC) compressor (s), hydraulic and pneumatic motors, and secondary water pumps used for fire suppression.

The main power source is therefore used only when the vehicle is required to provide power to the drive train wheels or larger high power required devices on the chassis. The removal of these parasitic loads allows an operator of the vehicle that ability to turn off the main power source when high power requirements are not needed but allow the vehicle to function in all other ways. The second power source allows other vehicle functionality to continue, including providing power for non-high energy loads such as heating, air conditioning, interior and exterior lighting, communications and infotainment, chassis and body control functions such a windows, door locks, and other related safety and convenience features as once provided for by the main power plant.

By providing a secondary power source, the main power source can be downsized, resulting in a proportionately smaller engine and reduced fuel and emission consumption. By adding a secondary power source to the vehicle, all parasitic loads can be removed from the main power source.

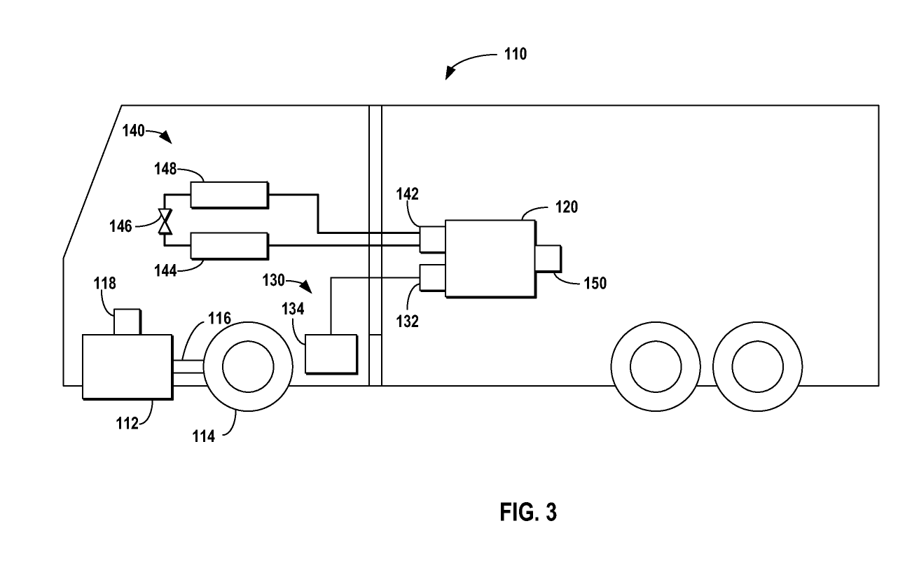

Referring to FIG. 3, a schematic block diagram of vehicle 110 with an improved power system is shown according to an exemplary embodiment. The vehicle 110 includes main power plant or power source 112. According to an exemplary embodiment, the main power source 112 is a diesel engine, but in other embodiments may also be a gasoline engine or any other suitable portable power source. The main power source 112 is coupled to a drive shaft 116 (e.g., through a transmission or other intermediary devices). The drive shaft 116, in turn, transfers the power to two or more wheels 114. The vehicle 110 may have one pair of driven wheels 114 coupled to the drive train or may have multiple pairs of driven wheels 114 (e.g., one or more pairs of rear wheels may also powered through the drive shaft 116).

The main power source 112 may also be configured to power a main pump 118 for the vehicle 110. The pump 118 may be configured to pump water from a source (e.g., a fire hydrant, a pool, a lake, etc.) so that the water or a foam can be output through hoses or stationary nozzles or deck guns.

The vehicle 110 further includes a secondary power source 120. According to an exemplary embodiment, the secondary power source 120 is a diesel engine, but in other embodiments may also be a gasoline engine or any other suitable portable power source (e.g., fuel cells, etc.). The secondary power source 120 can be mounted any suitable location on the vehicle, such as behind the cab of the vehicle 110.

The secondary power source 120 provides power for all of the vehicle's parasitic loads by powering one or more accessories. The secondary power source 120 allows other vehicle functionality to continue when the vehicle is stopped without running the main power source 112. The additional functionality is usually non-high energy loads that can be powered by a smaller power source than is needed to propel a vehicle. According to one exemplary embodiment, the secondary power source 120 is used to power an electrical system 130 and an HVAC system 140.

The electrical system 130 may be, for example, a 12 volt or 24 volt DC system typical for a fire truck or may be a higher voltage system, such as a 48 volt or 60 volt DC system. An alternator 132 is coupled to the secondary power source 120. The alternator 132 is driven by the secondary power source 120 to produce an alternating current which can be converted to a direct current with a device such as a rectifier. The electrical power from the alternator 132 is used to charge one or more batteries 134. Depending on the size and function of the vehicle 110, the batteries 134 may vary in type and number. For example, the batteries 134 may be lead acid batteries or another suitable electrochemical batteries (e.g., nickel-metal hydride (NiMH), lithium-ion, lithium-ion polymer, etc.). According to one exemplary embodiment, the vehicle 112 includes six lead acid batteries. The electrical system 130 is used to power a wide variety of devices on the vehicle, including hotel loads (e.g., fans and vehicle lighting), communications and infotainment devices (e.g., radios, GPS units, laptop computers, etc.), interior and exterior vehicle lighting, chassis and body control functions (e.g., power windows, power door locks, seat adjustment motors, etc.), and safety devices (e.g., seat occupant sensors, airbag deployment sensors, etc.). The electrical system 130 further provides power to devices associated with the vehicle's internal combustion engines (e.g., power sources 112 and 120) including fluid pumps, sensors, motors, and on-board computers. The electrical system 130 may also be used to power other devices for a fire truck such as sirens, water pumps, hydraulic pumps, ladder controls, etc.

The HVAC system 140 may be, for example, a vapor compression refrigeration system typically used in a vehicle. The HVAC system includes a compressor 142, a condenser 144, an expansion valve 146 and a evaporator 148. The compressor 142 may be, for example, a compressor that is commonly used in automotive applications and coupled to the main power source of the vehicle.

According to an exemplary embodiment, the secondary power source 120 may further be coupled to an AC generator 150 to provide AC electrical power. The AC generator 150 is capable of outputting AC power at 110, 220, and 440 volts at single or multiple phases depending on the application. The AC power may be used, for a variety of emergency tools such as hammers, drills, hydraulic rescue tools, exhaust fans, etc. In one exemplary embodiment, the vehicle 110 may be configured to act as mobile electrical power plant. For example, in emergency areas, the vehicle 110 may be able to provide electrical power for tents or other triage areas (e.g., to power medical instruments, to provide heating and cooling, to power lights, etc.) or even to provide electrical power to one or more homes.

Similar to existing vehicle power systems, rotational energy from the secondary power source 120 can be transferred to the accessories and peripheral devices through belts and pulleys (e.g., a serpentine belt), through direct drive through a power shaft, or via another device (e.g., a power take-off, a gearbox, a chain and sprocket system, etc.). According to an exemplary embodiment, the alternator 132 and the compressor 142 are driven by the secondary power source 120 through a belt and pulley system. The AC generator 150 is coupled to the output shaft of the second power source 120.

The electrical system 130 can be configured to interface with an electrical grid. Fire trucks are generally plugged into the electrical grid (e.g., shore power) when they return to the station after an emergency call. With the use of the secondary power source 120, vehicle 110 can recharge the batteries 134 of the electrical system 130 on the drive back to the station.

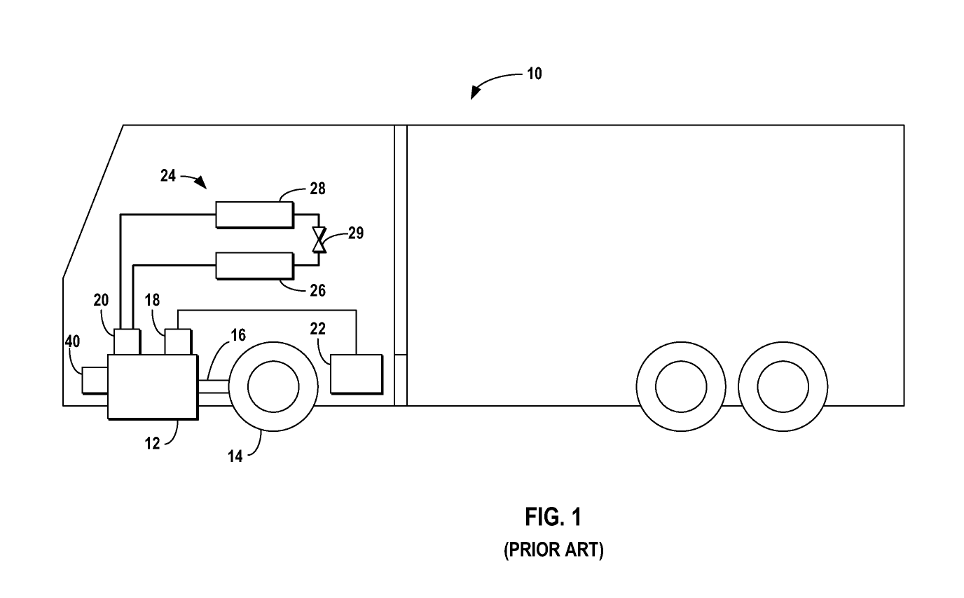

The secondary power source 120 can easily be retrofitted to existing vehicles, such as shown in FIG. 1. Fire trucks generally feature diesel generators that are mounted in existing space behind the cab of the vehicle. The secondary power source 120 can be installed in this location and be used to remove parasitic loads from the main power source 112. The chassis electrical alternator can be removed from the main power source 112 and integrated into the secondary power source 120 or may be removed and replaced by another alternator coupled to the secondary power source 120. Similarly, the chassis air conditioning compressor can be removed from the main power source 112 and integrated into the secondary power source 120 or may be removed and replaced by another compressor coupled to the secondary power source 120.

Many emergency situations to which a vehicle 110 such as a fire truck may be called do not involve a fire that needs to be suppressed. Fire trucks are often called to the scenes of traffic collisions, medical emergencies, and other emergency situations. Therefore, the main pump 118 of the vehicle 110 may not be needed for the entirety of the call. The use of the secondary power source 120 to power the parasitic loads and the removal of these loads from the main power source 112 can allow for near complete chassis functions while the main power source 112 is shut down.

The removal of the parasitic loads increases available power to the wheels 114 through the drive train and to the main pump 118 from the main power source 112. Because both the main power source 112 and the secondary power source 120 can be sized and configured for different power needs and duty cycles, fuel consumption can be reduced. Depending on the use of the vehicle, fuel consumption by 70%, compared to a traditionally configured vehicle, as shown in FIG. 1. The reduced fuel consumption further results in a reduction in the exhaust emissions produced by the vehicle. In addition, a reduction in the amount of idling time for the main power source 112 greatly reduces the wear on the main power source 112, reducing maintenance costs and extending the life of the main power source 112.

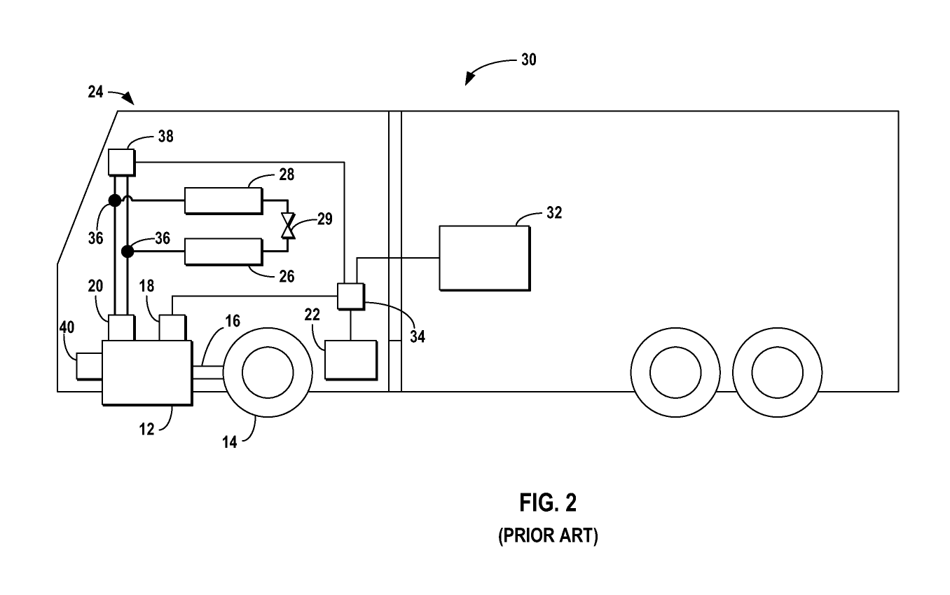

Unlike a system that runs in parallel with an existing system, as shown in FIG. 2, the vehicle 110 including the secondary power source 120 exclusively powering the parasitic loads does not require additional transfer switching or additional mechanical clutching or solenoid activation to balance the electrical and air conditioning systems.

The vehicle 110 including the secondary power source 120 is modular in design and allows for future additional adaptation of parasitic loads. Additionally, if the power drawn by parasitic loads exceed the power capabilities of the secondary power source 120, the secondary power source 120 can be replaced with a larger unit while the main power source 112 remains unchanged.

The use of the secondary power source 120 increases electrical DC capacity beyond typical chassis alternator configurations for conventional vehicles. Further, the use of an AC generator 150 coupled to the secondary power source 120 provides a method of supplying AC power at 120 VAC, 240 VAC, or even 440 VAC.

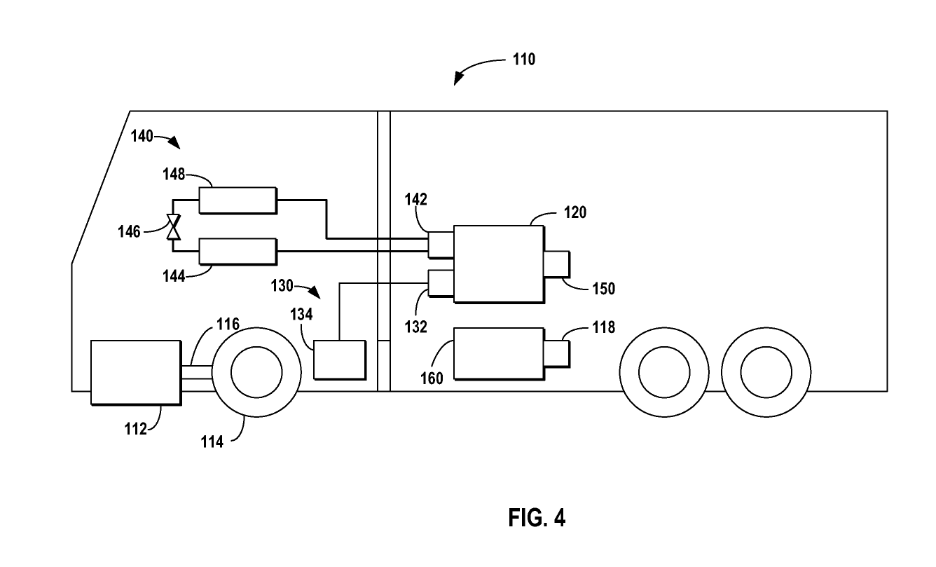

The main pump 118 is shown in FIG. 3 as being powered by the main power source 112, but in other embodiments, the main pump 118 may be powered by the secondary power source 120. In still other embodiments, as shown in FIG. 4, the main pump 118 may be powered by a third power source 160, such as a diesel engine. In this way, the main power source 112 can be optimized for driving the wheels 114 and the third power source 160 can be optimized to operate a high-power pump.

While the vehicle is described as having a conventional drive system, which includes a mechanical connection between the internal combustion engine or other power source and the wheels, in other embodiments, there may not be a direct mechanical connection between the power source and the wheels. Instead, the alternator may be used to provide power to the batteries and the wheels may then be driven by electric motors that draw power from the batteries.

The construction and arrangements of the vehicle power system, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A power system for a vehicle, comprising:
a first power source, the first power source configured to provide power to drive the wheels of the vehicle;
a second power source;
an electrical system powered by the second power source; and
an accessory powered by the second power source,
wherein the electrical system and the accessory do not draw power from the first power source.

2. The power system of claim 1, wherein the first power source and the second power source are diesel engines.

3. The power system of claim 2, wherein the second power source provides power to the electrical system via an alternator.

4. The power system of claim 3, wherein the accessory is one of a pump, a compressor, or an electrical generator.

5. The power system of claim 4, wherein the accessory is a compressor for a refrigeration system.

6. The power system of claim 3, wherein the alternator and the accessory are powered by the second power source via a belt.

7. The power system of claim 4, wherein the accessory is coupled to the output shaft of the diesel engine.

8. The power system of claim 7 wherein the accessory is an AC generator.

9. A vehicle, comprising:
a first power source;
a drive train including one or more driven wheels;
a second power source;
an electrical system powered by the second power source; and
an accessory powered by the second power source,
wherein the first power source powers the drive train and the electrical system and the accessory do not draw power from the first power source.

10. The vehicle of claim 9, wherein the vehicle is one of a fire truck, a delivery vehicle, an ambulance, or a utility vehicle.
